(19) United States
(12) Patent Application Publication
(10) Pub. No.: US 2022/0138558 A1
(43) Pub. Date: May 5, 2022

(54) DEEP SIMULATION NETWORKS

(71) Applicant: Microsoft Technology Licensing, LLC, Redmond, WA (US)

(72) Inventors: Ashish KAPOOR, Kirkland, WA (US); Sai Hemachandra VEMPRALA, Bellevue, WA (US); Ratnesh MADAAN, Seattle, WA (US)

(21) Appl. No.: 17/090,134

(22) Filed: Nov. 5, 2020

(51) Int. Cl. G06N 3/08; G06F 9/54; G06N 3/04

(52) U.S. Cl. CPC G06N 3/08; G06N 3/04; G06F 9/546

(57) ABSTRACT

Systems utilize a set of stored simulation nodes including an initial simulation node and a subsequent simulation node constructed according to a neural network computational fabric for simulating a physical process. These systems are configured to implement/utilize the set of simulation nodes by, at the initial simulation node, receiving initial state input, calculating an initial state evolution output, and generating an initial message vector output. At the subsequent simulation node, systems implement/utilize the set of simulation nodes by receiving a subsequent state input and a subsequent message vector input based on the initial message vector output to facilitate coordination between the initial and subsequent simulation nodes for calculating respective state evolution outputs for simulating the physical process or component. The systems are also configured to calculate a subsequent state evolution output based on the subsequent state input and the subsequent message vector input.

### BACKGROUND

Artificial intelligence may be implemented into many real-world systems, processes, and/or devices that interact with real-world environments and/or physical objects. Example applications may include, for instance, robotics and autonomous navigation (e.g., for vehicles, vessels, and/or aircraft). Many artificial intelligence implementations utilize predictive models or policies associated with neural networks to control real-world systems. In some instances, such neural networks are trained within a training environment to build a policy (e.g., a policy for resulting to particular situations) based on consequences resulting from different actions taken within the training environment (e.g., reinforcement learning). Real-world training environments are costly to implement and use for training a neural network, particularly for implementation on real-world devices that include complex or expensive physical components.

Accordingly, simulators may be used to train policies within a virtual environment, thereby avoiding costs and complications associated with building and/or maintaining real-world training environments. However, conventional simulators are associated with various drawbacks. For example, traditional simulators rely on sophisticated engineering efforts to create digital representations of careful orchestration of various complex components, which may limit the ability to create new simulations for rapidly evolving electromechanical systems. Furthermore, traditional simulators rely on carefully written code to create virtual environments that accurately capture the behavior of real-world physical processes or phenomena (e.g., laws of physics), making simulators for novel environments, components, and/or physical phenomena costly and/or time-consuming to generate, implement, or improve.

Thus, for at least the foregoing reasons, there is an ongoing need and desire for techniques for simulating physical processes or components.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include systems and methods for utilizing and configuring deep simulation networks.

Some embodiments include a system comprising one or more hardware storage devices that store a first set of simulation nodes. The first set of simulation nodes includes at least a first initial simulation node and at least a first subsequent simulation node, where the first initial and subsequent simulation nodes are constructed according to a neural network computational fabric and are associated with temporally consecutive simulation frames for simulating a first physical process or component. Some embodiments also include one or more processors configured to implement the first set of simulation nodes by configuring the system to, at the first initial simulation node, receive first initial state input, calculate a first initial state evolution output based on the first initial state input, and generate a first initial message vector output based on at least the first initial state input and/or the first initial state evolution output.

The system is also configured, in some embodiments, to receive a first subsequent state input and a first subsequent message vector input at the first subsequent simulation node based on the first initial message vector output, as well as to receive the first subsequent message vector input at the first subsequent simulation node facilitates coordination between the first initial and subsequent simulation nodes for calculating respective state evolution outputs for simulating the first physical process or component, and to calculate a first subsequent state evolution output based on the first subsequent state input and the first subsequent message vector input, and to generate a first subsequent message vector output based on the first subsequent message vector input, the first subsequent state input, and/or the first subsequent state evolution output.

Some embodiments include one or more processors and one or more hardware storage devices storing a deep simulation network comprising a set of simulation nodes associated with temporally consecutive simulation frames for modeling a physical process or component. The set of simulation nodes is configured with message passing functionality such that at least some of the set of simulation nodes are configured to generate message vector output and receive message vector input based on message vector output generated by other simulation nodes of the set of simulation nodes. The message passing functionality facilitates coordination among the set of simulation nodes for simulating the physical process or component.

The one or more hardware storage devices also stores instructions that are executable by the one or more processors to configure the system to train the deep simulation network by configuring the system to obtain a set of observations that capture evolution of the physical process or component and initializing a set of message vector parameters using a predetermined value. The set of message vector parameters being associated with a set of message vectors corresponding to the set of observations, and the set of message vectors comprising message vector inputs and message vector outputs associated with the set of simulation nodes.

In some instances, the system is further configured to determine model parameters for the deep simulation network by maximizing a log-likelihood of the deep simulation network providing outputs corresponding to the set of observations and by treating the message vector inputs and the message vector outputs of the set of message vectors as latent variables and marginalizing over the message vector inputs and the message vector outputs of the set of message vectors, as well as to update the set of message vector parameters based on the model parameters.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example system that may include or be used to implement one or more disclosed embodiments;

FIG. 2 illustrates an example conceptual representation of a deep simulation network configured for simulating evolution of a physical process or component;

FIG. 3 illustrates an example conceptual representation of a deep simulation network configured for simulating evolution of coupled physical processes or components;

FIG. 4 illustrates an example conceptual representation of a deep simulation network configured for simulating evolution of multiple interlinked physical processes or components;

FIG. 5 illustrates an example conceptual representation of a training procedure for training a deep simulation network; and

FIG. 6 illustrates example flow diagram depicting acts associated with implementing deep simulation networks.

### DETAILED DESCRIPTION

Disclosed embodiments are generally directed to systems and methods for facilitating message passing among simulation nodes to allow coordination amongst simulation nodes to simulate one or more physical processes or components.

### Examples of Technical Benefits, Improvements, and Practical Applications

Those skilled in the art will recognize, in view of the present disclosure, that at least some of the disclosed embodiments may be implemented to address various shortcomings associated with at least some conventional techniques for simulating physical processes or components. The following section outlines some example improvements and/or practical applications provided by the disclosed embodiments. It will be appreciated, however, that the following are examples only and that the embodiments described herein are in no way limited to the example improvements discussed herein.

In some implementations, a system may implement a deep simulation network that comprises a set of simulation nodes that are associated with temporally consecutive simulation frames for simulating a physical process or component. At each simulation node, the system may be configured to receive state input and message vector input. Based on the state input and/or the message vector input, the system may calculate state evolution output and message vector output. The message vector output may be passed to a subsequent simulation node associated with a temporally subsequent simulation frame. Such message passing between the simulation nodes may facilitate coordination among the simulation nodes while simulating the physical process or component, allowing incorporation of prior knowledge when generating output. This is in contrast with conventional neural networks (e.g., deep neural networks), which operate using statistical dependencies between state variables (and control inputs, in some instances) in a myopic fashion.

In addition, or as an alternative, to passing messages between temporally consecutive simulation nodes associated with the same physical process or component, messages may be passed among simulation nodes configured for modeling different physical processes or components to facilitate coordination while simulating simultaneously evolving physical processes or components.

In some implementations, the simulation nodes are configured to receive other types of inputs, such as time duration input, control input, and/or others. In this way, simulation nodes may be operable to simulate coordinated time evolution of one or more physical processes or components in response to different control inputs provided to or within the physical process(es) or component(s). Accordingly, at least some implementations of the present disclosure may advantageously provide counter-factual reasoning functionality for physical components (e.g., predictive if-then reasoning to determine whether to adopt a particular control). Furthermore, at least some implementations of the present disclosure may advantageously account for difference in time duration between simulation frames.

Those skilled in the art will appreciate, in view of the present disclosure, that deep simulation nodes may provide significant advantages over conventional systems, techniques, and structures for simulating physical processes or components. For instance, classical or standard simulation software is often outdated (sometimes written decades ago) and formed from carefully written code configured to simulate physical phenomena (e.g., fluid flow, physical mechanics, etc.). Accordingly, conventional simulations may be costly or difficult to improve or onboard on customer systems. Furthermore, it is often difficult, costly, and/or time-consuming to generate manually written code-based simulation software to simulate novel physical processes.

In contrast to existing systems, the deep simulation networks of the present embodiments are operable to build a simulation to simulate a physical process, component, or phenomenon based on training data, which may comprise observations of a real-world process/component that capture time evolution of the real-world process/component. Where the real-world process/component evolves differently in response to different control input, such control input may be provided as training data as well. Thus, an approach to building simulations that utilizes deep simulation networks may facilitate simulation generation in a more rapid, efficient manner (e.g., as compared with conventional approaches). Furthermore, rather than carefully crafted code, deep simulation networks may rely on a neural network computational fabric to facilitate simulations of physical processes/components, which may be easier to implement on customer systems.

Deep simulation networks of the present disclosure may also provide advantages over neural ordinary differential equations (neural ODEs), which attempt to model time-evolving systems. For example, neural ODEs are difficult to train because of the need to use numerical ODE solvers as a proxy for back propagation, which may cause significant latency. Furthermore, ODE solvers must be implemented when running a trained neural ODE, which adds to complexity of onboarding for end user systems. In contrast, deep simulation networks, according to the present disclosure, operate entirely within the neural network computational fabric without giving rise to the need of numerical solvers or other additional complexities.

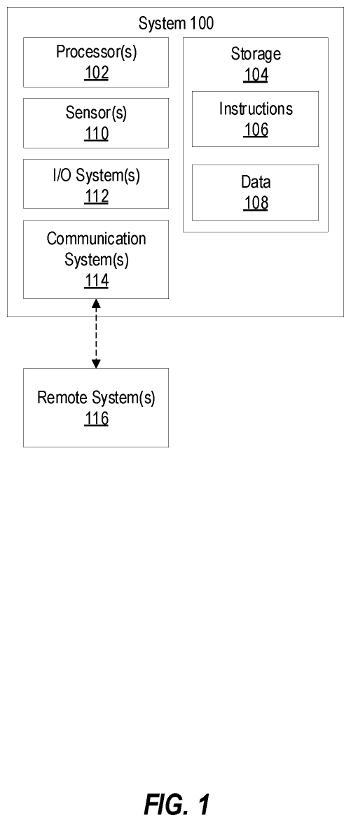

Having just described some of the various high-level features and benefits of the disclosed embodiments, attention will now be directed to FIGS. 1 through 6. These Figures illustrate various conceptual representations, architectures, methods, and supporting illustrations related to the disclosed embodiments.

### Example Systems and Techniques for Utilizing and Configuring Deep Simulation Networks

Attention is now directed to FIG. 1, which illustrates an example system 100 that may include or be used to implement one or more disclosed embodiments. In some instances, the system 100 is implemented as one or more general-purpose or special purpose computing systems, which may take on a variety of forms.

FIG. 1 illustrates various example components of the system 100. For example, FIG. 1 illustrates an implementation in which the system includes processor(s) 102, storage 104, sensor(s) 110, I/O system(s) 112, and communication system(s) 114. Although FIG. 1 illustrates a system 100 as including particular components, one will appreciate, in view of the present disclosure, that a system 100 may comprise any number of additional or alternative components.

The processor(s) 102 may comprise one or more sets of electronic circuitry that include any number of logic units, registers, and/or control units to facilitate the execution of computer-readable instructions (e.g., instructions that form a computer program). Such computer-readable instructions may be stored within storage 104. The storage 104 may comprise physical system memory and may be volatile, non-volatile, or some combination thereof. Furthermore, storage 104 may comprise local storage, remote storage (e.g., accessible via communication system(s) 114 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

A deep simulation network may be stored within storage 104 in the form of instructions 106 constructed according to neural network computational fabric. A deep simulation network may comprise various sets of simulation nodes, where each simulation node is associated with various parameters that may be modified (e.g., during training) to configure the deep simulation network to simulate various physical phenomena, processes, and/or components. The various simulation nodes may be associated with temporally consecutive simulation frames for simulating a physical process or component.

As will be described in more detail, the processor(s) 102 may be configured to execute instructions 106 stored within storage 104 to perform certain actions associated with implementing deep simulation networks. For instance, such actions may be associated with training or configuring a deep simulation network to simulate physical processes or components. By way of example, the processor(s) 102 may execute instructions 106 associated with a training procedure for modifying parameters associated with various simulation nodes of a deep simulation network to configure the deep simulation network for simulating a particular physical process, component, or phenomenon. A training procedure may rely on various types of data 108 stored within storage 104, such as training data based on observations of the evolution of one or more physical phenomena, processes, and/or components.

In some instances, the processor(s) 102 may be configured to execute instructions 106 associated with actions for implementing a deep simulation network to simulate a physical phenomenon, process, and/or component. Such simulations may also rely on various types of data 108 stored within storage 104, such as state data, control data, time duration data, and/or others.

In some instances, facilitating the actions associated with deep simulation networks may rely at least in part on communication system(s) 114 for receiving data from or facilitating coordinated execution with remote system(s) 116. Remote systems may include, for example, separate systems or computing devices, sensors, and/or others. The communications system(s) 114 may comprise any combination of software or hardware components that are operable to facilitate communication between on-system components/devices and/or with off-system components/devices. For example, the communications system(s) 114 may comprise ports, buses, or other physical connection apparatuses for communicating with other devices/components. Additionally, or alternatively, the communications system(s) 118 may comprise systems/components operable to communicate wirelessly with external systems and/or devices through any suitable communication channel(s), such as, by way of non-limiting example, Bluetooth, ultra-wideband, WLAN, infrared communication, and/or others.

In some instances, facilitating the actions associated with deep simulation networks may rely at least in part on data (e.g., data 108) obtained via sensor(s) 110 associated with the system 100. Such sensor(s) 110 may comprise any system or device for capturing or measuring data representative of perceivable phenomenon. By way of non-limiting example, the sensor(s) 110 may comprise one or more image sensors, microphones, thermometers, barometers, magnetometers, accelerometers, gyroscopes, and/or others.

Furthermore, in some instances, facilitating the actions associated with deep simulation networks may rely at least in part on I/O system(s) 112 associated with the system 100. I/O system(s) 112 may include any type of input or output device such as, by way of non-limiting example, a touch screen, a mouse, a keyboard, a controller, and/or others, without limitation. For example, the system 100 may receive control input to simulate evolution of a physical phenomenon based on the control input.

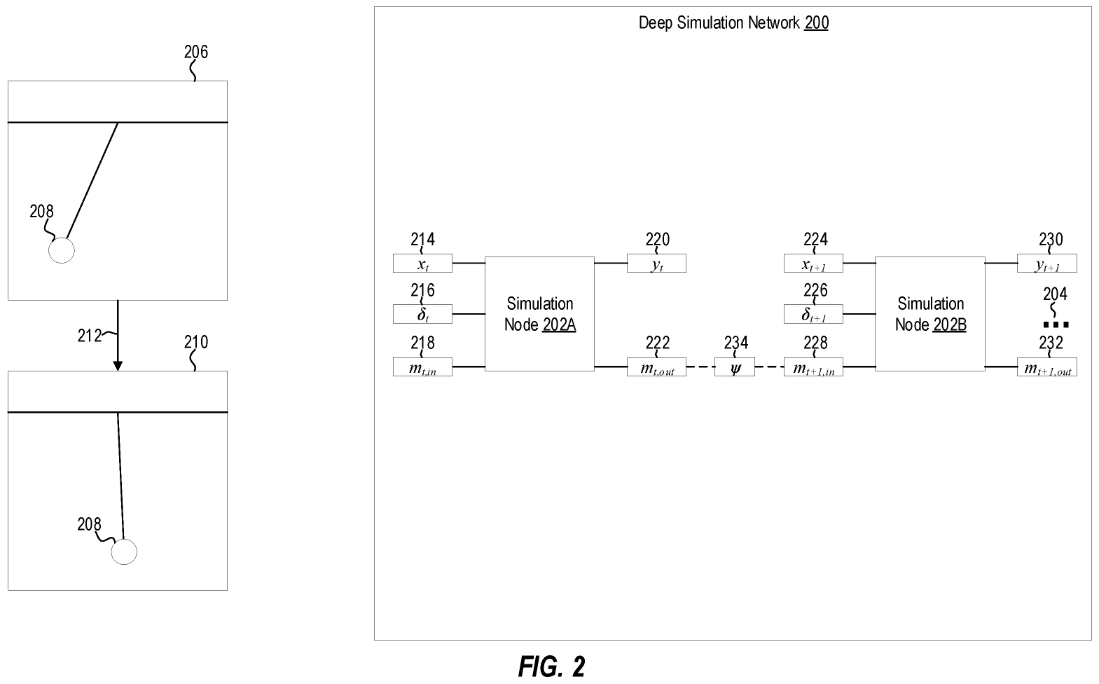

FIG. 2 illustrates an example conceptual representation of a deep simulation network 200 configured for simulating evolution of a physical process or component. As indicated hereinabove, the deep simulation network 200 may be stored on storage 104 and may comprise various simulation nodes. FIG. 2 illustrates the deep simulation network 200 as including a first set of simulation nodes, comprising simulation node 202A and simulation node 202B. The ellipsis 204 indicates that a deep simulation network may comprise any number of simulation nodes in accordance with the present disclosure.

Simulation nodes (e.g., simulation nodes 202A and 202B) may comprise a core building block of a deep simulation network for modeling time evolution of a physical process or component. A simulation node may be modeled as a function that operates on a state of a component and a time duration associated with the component to compute an output representative of time evolution of the component. Simulation nodes may coordinate and communicate with one another via message vectors. For example, a simulation node may receive an input message vector as an additional input and may compute an output message vector as an additional output. These input and output message vectors may be used to coordinate with other simulation nodes to facilitate coordinated, intelligent simulation of time evolution of a physical process or component. For example, inputs and outputs of a simulation node may be formally represented as:

[y,mₒᵤₜ]=f_{DSN}(x,δ,mᵢₙ)

where f_{DSN} represents a simulation node, x represents a state of a component, δ represents time duration, mᵢₙ represents an input message vector, y represents an indication of time evolution of the component, and mₒᵤₜ represents an output message vector.

The first set of simulation nodes of the deep simulation network 200 of FIG. 2 is, in some implementations, configured for simulating state evolution a first physical process or component. In this regard, the various simulation nodes 202A, 202B, etc. may be associated with temporally consecutive simulation frames for simulating the first physical process or component.

To illustrate, FIG. 2 illustrates an initial frame 206 that includes a representation of a pendulum 208. The initial frame 206 may be associated with various state information for the pendulum 208, such as the positional characteristics of the pendulum 208 (e.g., the angle of the string of the pendulum 208), motion characteristics of the pendulum 208 (e.g., velocity, acceleration, etc.), and/or others. The initial frame 206 may also be associated with any control input associated with the pendulum (e.g., driving forces and/or other forces acting upon the pendulum 208).

Based on the state information (e.g., and/or control information, if any) associated with the pendulum 208 according to the initial frame 206, the pendulum 208 may evolve into a different state, which is illustrated in FIG. 2 according to a subsequent frame 210 that also includes a representation of the pendulum 208 at a timepoint that is subsequent to a timepoint associated with the initial frame 206. The arrow 212 extending from the initial frame 206 to the subsequent frame 210 within FIG. 2 illustrates a duration of time or temporal displacement between the initial frame 206 and the subsequent frame 210.

A deep simulation network 200 may be configured to estimate initial state evolution information for the pendulum 208 based on initial state information for the pendulum 208 (e.g., depicted in FIG. 2 by the initial frame 206). Such initial state evolution information (and, in some instances, the time duration information represented in FIG. 2 by arrow 212) may provide an estimation of subsequent state information for a subsequent state of the pendulum 208 (depicted in FIG. 2 by the subsequent frame 210). The subsequent state information for the pendulum 208 may be used to estimate subsequent state evolution for the pendulum 208.

For example, simulation node 202A of deep simulation network 200 may be configured to receive various inputs associated with an initial state of a physical process or component (e.g., pendulum 208 according to initial frame 206). FIG. 2 illustrates that simulation node 202A may receive initial state input 214 (xₜ), initial time duration input 216 (δₜ), and/or initial message vector input 218 (m_{t,in}). As indicated above, the initial state input 214 may comprise any type of information describing a current status or state associated with a physical process or component. For instance, continuing the example related to the pendulum 208, the initial state input 214 may comprise positional information for the pendulum 208 (e.g., the angle of the string of the pendulum 208), motion information for the pendulum 208 (e.g., velocity, acceleration, etc.). In other examples, the initial state input 214 may comprise other types of data, such as voltage information, temperature information, force information, gradient or flow information, and/or other types of continuous or discrete information.

In some instances, such as where the simulation node 202A is a first simulation node of a deep simulation network 200 configured for estimating state evolution from a temporally first state, the initial message vector input 218 may be set to zero. In other instances, such as where the simulation node 202A is configured to estimate state evolution based on state information estimated by a prior simulation node, the initial message vector input 218 may be based on message vector output provided by the prior simulation node.

The time duration input 216 may be associated with the amount of time set to intervene between an initial simulation frame associated with simulation node 202A and a subsequent simulation frame associated with simulation node 202B.

Based on the various inputs (e.g., the initial state input 214, initial time duration input 216, and/or initial message vector input 218), the simulation node 202A may be configured for calculating an initial state evolution output 220 (yₜ). As noted hereinabove, the initial state evolution output 220 may be representative of expected evolution of the physical component or process (e.g., pendulum 208) over a time period (e.g., time duration input 216). For example, in some instances, the initial state evolution output 220 corresponds to a time derivative of the initial state input 214. Although not explicitly shown in FIG. 2, a state evolution output may also be based on control input received at a simulation node.

Furthermore, based on the various inputs (e.g., the initial state input 214, initial time duration input 216, initial message vector input 218, and/or control input if any) and/or the initial state evolution output 220 computed at the simulation node 202A, the simulation node 202A may be configured to generate an initial message vector output 222 (m_{t,out}). In some instances, the initial message vector output 222 may be considered a correction term for the initial state evolution output 220. For example, the initial message vector output 222 may be used in conjunction with the initial state evolution output 220 to in order to control for divergence and/or error that may otherwise occur when calculating state evolution and/or subsequent states for an evolving system.

As is evident from FIG. 2, the various inputs and outputs associated with simulation node 202A are noted with the subscript t, indicating that each input and output of simulation node 202A may be associated with the same initial temporal simulation frame for simulating a physical process or component (e.g., pendulum 208 as represented in initial frame 206). FIG. 2 illustrates simulation node 202A as being associated with various inputs and outputs, including subsequent state input 224 (xₜ₊₁), subsequent time duration input 226 (δₜ₊₁), subsequent message vector input 228 (m_{t+1,in}), subsequent state evolution output 230 (yₜ₊₁), and subsequent message vector output 232 (m_{t+1,out}). The various inputs and outputs of simulation node 202B are associated with the same subsequent temporal simulation frame for simulating the physical process or component (e.g., pendulum 208 as represented in subsequent frame 210), where the subsequent temporal simulation frame is subsequent to the initial temporal simulation frame associated with simulation node 202A.

In some instances, the subsequent state input 224 received at simulation node 202B may represent a subsequent state calculated for a physical process or component based on the initial state input 214, the initial state evolution output 220, and/or the time duration input 216 associated with simulation node 202A. For example, the subsequent state input 224 may represent the position and/or motion of the pendulum 208 as represented in subsequent frame 210, which may comprise a predicted position and/or motion for the pendulum 208 based on initial state information for the pendulum as represented in initial frame 206, the initial state evolution output 220 for the pendulum (e.g., calculated at simulation node 202A), and the duration of time indicated by arrow 212 (e.g., initial time duration input 216).

The subsequent time duration input 226 is similar to the initial time duration input 216. For example, the subsequent time duration input 226 may indicate an amount of time prior to a simulation frame that follows the subsequent simulation frame associated with simulation node 202B (e.g., associated with subsequent frame 210).

FIG. 2 shows, by dashed lines, that simulation node 202B receives subsequent message vector input 228 and illustrates that the subsequent message vector input 228 and the initial message vector output 222 of simulation node 202A are coordinated with one another. For instance, the subsequent message vector input 228 of simulation node 202B may be identified based at least in part on the initial message vector output 222 of simulation node 202A. Coordinating the message vector input of simulation node 202B with the message vector output of simulation node 202A may allow simulation node 202B to use information from simulation node 202A as context for calculating/predicting the subsequent state evolution output (e.g., for simulating the pendulum 208).

FIG. 2 illustrates a potential function 234 (ψ) connecting the initial message vector output 222 of simulation node 202A with the subsequent message vector input 228 of simulation node 202B. In this regard, FIG. 2 illustrates that a potential function may facilitate coordination between simulation node 202A and temporally consecutive simulation node 202B for simulating a physical process or component (e.g., pendulum 208). A potential function for connecting message vectors of different simulation nodes can be a positive and real function that operates on message vectors of various simulation nodes of a deep simulation network. A potential function may also incorporate any input and output variables that are available to the simulation nodes, such as state, state evolution, time duration, control, etc. In some instances, high evaluation of a potential function indicates good alignment and coordination among simulation nodes of a deep simulation network, while a lower evaluation may denote poor compatibility.

An example potential function for coordinating message vectors of consecutive simulation nodes may take on various forms, such as

ψ=exp{−∥m_{t+1,in}−m_{t,out}∥²}

where the term ∥m_{t+1,in}−m_{t,out}∥² connects the initial message vector output 222 (m_{t+1,in}) as the subsequent message vector input 228 (m_{t,out}). Such a term simply impose a constraint that the initial message vector output 222 of simulation node 202A is directly provided as subsequent message vector input 228 of simulation node 202A. Such a formulation may be beneficial in some instances but may result in certain disadvantages in others. For example, in some instances, time-derivatives of state inputs may not be constant over a time duration (e.g., initial time duration input 216). Thus, errors may accumulate in simulations for larger time duration inputs.

Although the message vectors may help to account for such error, the effectiveness of message vectors may be improved by providing some supervision as to how the messages could reduce errors. For example, a potential function may be written as follows:

ψ=exp{−λ∥xₜ+yₜδₜ+m_{t,out}−xₜ₊₁∥²−∥m_{t+1,in}−m_{t,out}∥²}

where the term −∥xₜ+yₜδₜ+m_{t,out}−xₜ₊₁∥², which is based on the initial state input 214 (xₜ), the initial time duration input 216 (δₜ), the initial state evolution output 220 (yₜ), and the subsequent state input 224 (xₜ₊₁), provides that, in some instances, the initial message vector output 222 (m_{t,out}) approximates residual errors in a Taylor approximation. Such a term may act as a supervisory signal toward the messages and may well-condition the subsequent state evolution estimates. As before, the term ∥m_{t+1,in}−m_{t,out}∥² connects the initial message vector output 222 (m_{t,out}) as the subsequent message vector input 228 (m_{t+1,in}). The hyperparameter λ determines the relative strengths of the two terms. Potential functions for connecting message vectors of various simulation nodes of a deep simulation network may be modified to provide great flexibility and to provide the ability to incorporate task-specific supervision for injecting prior knowledge.

Thus, simulation node 202B can interpret the incoming message vector (e.g., subsequent message vector input 228 (m_{t+1,in}), which is based on initial message vector output 222 (m_{t,out})) as context to be considered when predicting outputs (e.g., subsequent state evolution output 230 (yₜ₊₁)) Simulation node 202B may thus utilize the incoming message vector and/or additional inputs (e.g., subsequent state input 224, subsequent time duration input 226, subsequent control input, etc.) to calculate subsequent state evolution output 230 in a coordinated manner, using prior knowledge from previous simulation nodes. As before, the subsequent state evolution output 230 may correspond to a time derivative of the subsequent state input 224.

Simulation node 202B may also generate a subsequent message vector output 232 (m_{t+1,out}) based on one or more of the inputs and/or outputs associated with simulation node 202B (e.g., subsequent state input 224, subsequent time duration input 226, subsequent message vector input 228, subsequent control input, subsequent state evolution output 230, etc.). Message vector inputs for later simulation nodes may be based on the subsequent message vector output 232. In this way, a deep simulation network 200 may coordinate state evolution predictions across an entire sequence of simulation nodes to facilitate simulation of a physical component or process. For example, because of message passing, a deep simulation network 200 may handle instances where different time intervals or durations exist between different simulation frames, in particular because the message vectors enable accounting for different levels of approximation errors and can help create a context for appropriate corrections to be made.

In addition to facilitating coordination across time for temporally consecutive simulation nodes for simulating the same physical process or component, message passing functionality (e.g., utilizing potential functions) may be implemented to facilitate coordinated evolution between different sets of simulation nodes for simulating interlinked physical components or processes.

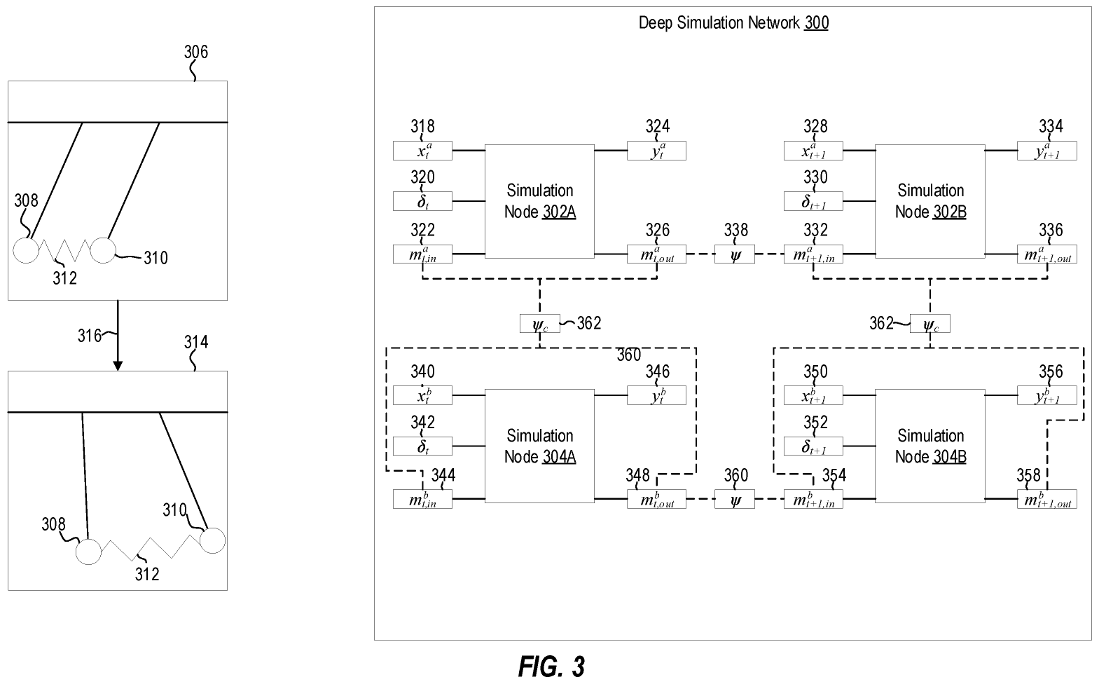

FIG. 3 illustrates an example conceptual representation of a deep simulation network 300 configured for simulating evolution of coupled physical processes or components. As indicated hereinabove, the deep simulation network 300 may be stored on storage 104 and may comprise various simulation nodes. FIG. 3 illustrates the deep simulation network 300 as including a first set of simulation nodes, comprising simulation node 302A and simulation node 302B. FIG. 3 also illustrates the deep simulation network 300 as including a second set of simulation nodes, comprising simulation node 304A and simulation node 304B. Each set of simulation nodes may comprise any number of simulation nodes.

The first set of simulation nodes of the deep simulation network 300 of FIG. 3 is, in some implementations, configured for simulating state evolution a first physical process or component, whereas the second set of simulation nodes of the deep simulation network 300 of FIG. 3 is, in some implementations, configured for simulating state evolution of a second physical process or component that is interlinked with the first physical process or component. The various simulation nodes of the first set of simulation nodes (e.g., simulation nodes 302A, 302B, etc.) may be associated with temporally consecutive simulation frames for simulating the first physical process or component, and, similarly, the various simulation nodes of the second set of simulation nodes (e.g., simulation nodes 304A, 304B, etc.) may be associated with temporally consecutive simulation frames for simulating the second physical process or component.

By way of illustration, FIG. 3 shows an initial frame 306 that includes a representation of a first pendulum 308 and a second pendulum 310. The first pendulum 308 and the second pendulum 310 are coupled to one another via a spring 312. The initial frame 206 may be associated with first state information for pendulum 308 second state information for pendulum 310. Such state information may include positional characteristics of the pendula 308 and 310 (e.g., the angles of the respective strings of the pendula 308 and 310), motion characteristics of the pendula 308 and 310 (e.g., velocity, acceleration, etc.), and/or others (e.g., spring forces or other forces acting on the pendula 308 and 310).

Based on the state information (e.g., and/or control information, if any) for the different pendula 308 and 310 (e.g., according to the initial frame 306), the pendula 308 and 310 may evolve into different states, which is illustrated in FIG. 3 according to a subsequent frame 314 that also includes representations of the pendula 308 and 310 at a timepoint that is subsequent to a timepoint associated with the initial frame 306. The arrow 316 extending from the initial frame 306 to the subsequent frame 314 within FIG. 3 illustrates a duration of time or temporal displacement between the initial frame 306 and the subsequent frame 314.

The first set of simulation nodes of the deep simulation network 300 (e.g., simulation nodes 302A, 302B, etc.) may be configured to estimate initial state evolution information for pendulum 308 based on initial state information for the pendulum 308, and the second set of simulation nodes of the deep simulation network 300 (e.g., simulation nodes 304A, 304B, etc.) may be configured to estimate initial state evolution information for pendulum 310 based on initial state information for the pendulum 310. Such initial state evolution information for the pendula 308 and 310 (and, in some instances, the time duration information represented in FIG. 3 by arrow 316) may provide estimates of subsequent state information for subsequent states of the pendula 308 and 310 (depicted in FIG. 2 by the subsequent frame 210). The subsequent state information for the pendula 308 and 310 may be used to estimate subsequent state evolution for the pendula 308 and 310.

For example, FIG. 3 illustrates simulation node 302A and simulation node 302B of the first set of simulation nodes as being configured for receiving inputs and providing outputs associated with pendulum 308. Such inputs and outputs may be generally similar to those described hereinabove with reference to simulation nodes 202A and 202B of deep simulation network 200 of FIG. 2. For example, FIG. 3 shows that simulation node 302A is configured to receive first initial state input 318 (xₜ^{a}), first initial time duration input 320 (δₜ), and first initial message vector input 322 (m_{t,in}^{a}), and is configured to output first initial state evolution output 324 (yₜ^{a}) and first initial message vector output 326 (m_{t,out}^{a}). Similarly, simulation node 302B is configured to receive first subsequent state input 328 (xₜ₊₁^{a}), first subsequent time duration input 330 (δₜ₊₁), and first subsequent message vector input 332 (m_{t+1,in}^{a}), and is configured to output first subsequent state evolution output 334 (yₜ₊₁^{a}) and first subsequent message vector output 336 (m_{t+1,out}^{a}).

FIG. 3 also shows that the message vectors of the first set of simulation nodes (e.g., simulation nodes 302A, 302B, etc.) may be connected to facilitate coordination via a potential function 338 (ψ), which may be generally similar to the potential function 234 described hereinabove with reference to deep simulation network 200 of FIG. 2.

FIG. 3 also illustrates simulation node 304A and simulation node 304B of the second set of simulation nodes as being configured for receiving inputs and providing outputs associated with pendulum 310. For example, FIG. 3 shows that simulation node 304A is configured to receive second initial state input 340 (xₜ^{b}), second initial time duration input 342 (δₜ), and second initial message vector input 344 (m_{t,in}^{b}), and is configured to output second initial state evolution output 346 (yₜ^{b}) and second initial message vector output 348 (m_{t,out}^{b}). Similarly, simulation node 304B is configured to receive second subsequent state input 350 (xₜ₊₁^{b}), second subsequent time duration input 352 (δₜ₊₁), and second subsequent message vector input 354 (m_{t+1,in}^{b}), and is configured to output second subsequent state evolution output 356 (yₜ₊₁^{b}) and second subsequent message vector output 358 (m_{t+1,out}^{b}).

FIG. 3 also shows that the message vectors of the second set of simulation nodes (e.g., simulation nodes 304A, 304B, etc.) may be connected to facilitate coordination via a potential function 360 (ψ), which may be generally similar to the potential function 234 described hereinabove with reference to deep simulation network 200 of FIG. 2.

FIG. 3 also illustrates additional coupling potential functions 362 (ψ_{c}) configured to connect simulation nodes of the different sets of simulation nodes that are associated with simulating the different pendula 308 and 310. For instance, FIG. 3 shows one or more message vectors of simulation node 302A (e.g., first initial message vector input 322 and/or first initial message vector output 326) of the first set of simulation nodes connected to one or more message vectors of simulation node 304A (second initial message vector input 344 and/or second initial message vector output 348) of the second set of simulation nodes via a coupling potential function 362. Similarly, FIG. 3 shows one or more message vectors of simulation node 302B (e.g., first subsequent message vector input 332 and/or first subsequent message vector output 336) of the first set of simulation nodes connected to one or more message vectors of simulation node 304B (second subsequent message vector input 354 and/or second subsequent message vector output 358) of the second set of simulation nodes via a separate coupling potential function 362. Such coupling potential functions may facilitate message passing among simulation nodes configured for simulating different physical components or processes of a physical system. In this regard, a deep simulation network 300 may facilitate coordination across simulation nodes across time (e.g., via potential functions 338 and 360) and across different components (e.g., via coupling potential functions 362).

Coupling potential functions for tying different sets of simulation nodes together may take on various forms. For example, a coupling potential function 362 may be represented as follows:

ψ_{c}=exp{−∥m_{b,in}−m_{a,out}∥²−∥m_{a,in}−m_{b,out}∥²}

where m_{a,in} and m_{a,out} generally represent message vector input and message vector output, respectively, for a simulation node of a first set of simulation nodes (e.g., configured for simulating a first physical process or component) and m_{b,in} and m_{b,out} generally represent message vector input and message vector output, respectively, for a simulation node of a second set of simulation nodes (e.g., configured for simulating a second physical process or component that is interlinked with the first physical process or component). Such a potential function may directly connect inputs and outputs across different sets of simulation nodes to facilitate coordination between the sets of simulation nodes by cross-feeding the message vectors between the simulation nodes for each interlinked physical process or component.

In some instances, a coupling potential function 362 may be represented as follows:

ψ_{c}=exp{w^{T}M}, where: M=[m_{a,in},m_{a,out},m_{b,in},m_{b,out}]^{T}

and where w^{T} represents a linear projection for aligning the messages for each time slice t∈T representing a different simulation frame and corresponding simulation node. Such a potential function may also directly connect inputs and outputs across different sets of simulation nodes to facilitate coordination between the sets of simulation nodes by cross-feeding the message vectors between the simulation nodes for each interlinked physical process or component.

In some instances, corresponding simulation nodes of the different sets of simulation nodes (e.g., simulation node 302A and simulation node 304A) are associated with the same temporal slice for simulating the interlinked physical processes or components. In other instances, at least some corresponding simulation nodes of the different sets of simulation nodes are associated with temporal slices that are at least partially offset from one another.

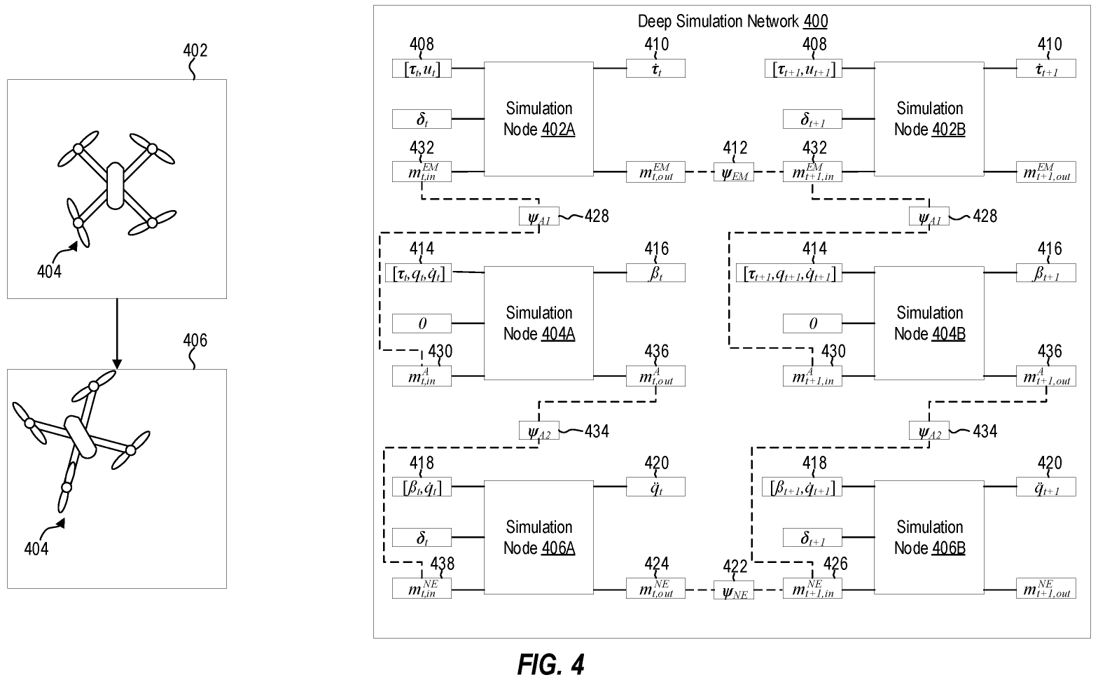

Although FIG. 3 focuses on a deep simulation network 300 comprising two sets of simulation nodes (e.g., a first set comprising simulation nodes 302A, 302B, and so forth, and a second set comprising simulation nodes 304A, 304B, and so forth) configured for simulating evolution of two coupled physical processes or components (e.g., pendulum 308 and pendulum 310 coupled via spring 312), a deep simulation may comprise any number of sets of simulation nodes for simulating any number of physical processes or components. For example, FIG. 4 illustrates an example conceptual representation of a deep simulation network 400 configured for simulating evolution of multiple interlinked physical processes or components.

To illustrate, FIG. 4 includes a representation of an initial frame 402 that includes a representation of a quadrotor 404. Simulation of a quadrotor may involve complex systems with many different components that operate across multiple interlinked domains of physics. For example, a quadrotor 404 comprises electrical components, such as motors, that actuate upon application of electrical current. Such motors may be connected to propellers that provide thrust to the quadrotor 404 based on their aerodynamic characteristics. Furthermore, a quadrotor may encounter air drag when moving through the air, and such air drag may be dependent on the physical profile of the quadrotor 404 as well as the velocity of the quadrotor 404. Thus, the trajectory of a quadrotor 404 may depend on several different physical processes, and these different physical processes may be interlinked with and affect the responses of each other (e.g., motor speed may depend on current applied, air drag acting on a propeller connected to the motor, and the motion of the quadrotor 404).

In view of the foregoing, estimating state evolution and/or subsequent state of a quadrotor 404 (e.g., as depicted in FIG. 4 within subsequent frame 406 with time period intervening between the subsequent frame 406 and the initial frame 402) is associated with many challenges. FIG. 4 shows how a deep simulation network 400 may be used to simulate the various physical processes associated with a moving quadrotor 404 in a coordinated manner.

Simulating a quadrotor 404 may involve simulating a plurality of physical phenomena, such as electro-mechanical, aerodynamic drag, and Newton-Euler dynamics. The electro-mechanical part of the simulation may model resultant rotor thrust and torque, τ∈ [symbol] ⁸, upon application of electrical pulse-width modulated (PWM) signals to each of the motors, u∈ [symbol] ⁴. The rotor thrusts and torques are affect not only by PWM signals, but the propeller characteristics, electrical hysteresis, and physical inertia.

The aerodynamic drag part of the simulation may consider the rotor thrusts and torques, τ, along with the current position or pose of the quadrotor 404, q∈ [symbol] ⁶ (e.g., pose in six degrees of freedom, such as x, y, z, pitch, roll, and yaw) and the corresponding velocities, \dot{q}, to compute net body forces and moments, β∈ [symbol] ⁶. The resulting body forces and torques may account for both rotor thrusts and torques, τ, as well as state-dependent aerodynamic drag resulting due to the motion of the quadrotor 404 in the air.

Newton-Euler dynamics may consider body forces and moments, β, and velocities, \dot{q}, to determine resulting accelerations, \ddot{q}, such that natural laws of physics are preserved.

As noted above, the outputs across the various parts of the simulation affect each other. For instance, aerodynamic drag may affect how a motor responds to PWM signals, and accelerations, \ddot{q}, may affect future positions, q, and velocities, \dot{q}, which may in turn affect body forces and moments, β. Furthermore, the various outputs may be coupled via Newton-Euler dynamics.

Thus, the deep simulation network 400 of FIG. 4 includes a first set of simulation nodes (e.g., simulation nodes 402A, 402B, etc.), a second set of simulation nodes (e.g., simulation nodes 404A, 404B, etc.), and a third set of simulation nodes (simulation nodes 406A, 406B, etc.). The first set of simulation nodes may be configured for simulating electro-mechanical (EM) processes by receiving input 408 in the form of [τ, u] and generating output 410 in the form of t (temporally indexed for time slice or simulation frame). FIG. 4 also illustrates a potential function 412 (ψ_{EM}) for facilitating message passing among the first set of simulation nodes. The potential function 412 may correspond to the potential functions 234 and 338 described hereinabove with reference to FIGS. 2 and 3, respectively.

The second set of simulation nodes (e.g., simulation nodes 404A, 404B, etc.) may be configured for simulating aerodynamic drag (A) by receiving input 414 in the form of [τ, q, \dot{q}] and generating output 416 in the form of β (temporally indexed for time slice or simulation frame). In some instances, the various simulation nodes of the second set of simulation nodes are not connected across time via potential functions, in particular because the mappings between the input 414 and the output 416 are instantaneous.

The third set of simulation nodes (e.g., simulation nodes 406A, 406B, etc.) may be configured for simulating Newton-Euler dynamics (NE) by receiving input 418 in the form of [β,\dot{q}] and generating output 420 in the form of q (temporally indexed for time slice or simulation frame). FIG. 4 also illustrates a potential function 422 (ψ_{NE}) for facilitating message passing among the third set of simulation nodes. The potential function 422 may take on various forms. In some implementations a potential function 422 may be represented as follows:

$${ψ}_{NE} = exp \{ - λ {‖ {q}_{t} + {\dot{q}}_{t} {δ}_{t} + \frac{1}{2} ( {y}_{t} + {m}_{t , out}^{NE} ) {δ}_{t}^{2} - {q}_{t + 1} ‖}^{2} - {‖ {m}_{t , out}^{NE} - {m}_{t + 1 , in}^{NE} ‖}^{2} \} .$$

The potential function 422 may inject prior knowledge in a manner that provides supervision to the message vectors of the various simulation nodes of the third set of simulation nodes. For instance, the potential function 422 may implicitly connect the third initial message vector output 424 (m_{t,out}^{NE}) to the third subsequent message vector input 426 (m_{t+1,in}^{NE}), the potential function 422 may specifically include the appropriate laws of physics to help prevent the estimated position of the quadrotor 404 from deviating significantly from the ground truth. The potential function 422 also provides that one of the roles of the message vectors of the third set of simulation nodes is to preserve the approximation error in estimating the acceleration along the prediction chain.

FIG. 4 also illustrates how the second set of simulation nodes (e.g., simulation nodes 404A, 404B, etc.) may be coupled with the other sets of simulation nodes via potential functions operating on the message vectors. For instance, FIG. 4 illustrates potential functions 428 (ψ_{A1}) connecting the message vector inputs 430 of the second set of simulation nodes to the message vector inputs 432 of the first set of simulation nodes. FIG. 4 also illustrates potential functions 434 (ψ_{A2}) connecting the message vector outputs 436 of the second set of simulation nodes to the message vector inputs 426 and 438 of the third set of simulation nodes. Such potential functions 428 and 434 may take on various forms. For example, in some implementations, potential functions 428 and 434 may, respectively, be represented as follows:

ψ_{A1}=exp{−∥m_{t,out}^{EM}−m_{t,in}^{A}∥²} and ψ_{A2}=exp{−∥m_{t,out}^{A}−m_{t,in}^{NE}∥²}.

The potential function 428 (ψ_{A1}) may ensure that incoming messages are shared for both the first set of simulation nodes (for simulating EM) and the second set of simulation nodes (for simulating A). The potential function 434 (ψ_{A2}) may connect the message output of the second set of simulation nodes (for simulating A) to the third set of simulation nodes (for simulating NE). Such a configuration may allow additional information based on the β output of the second set of simulation nodes to be passed to the third set of simulation nodes (for simulating NE).

Accordingly, deep simulation networks may be utilized to facilitate coordinated simulation of complex physical systems with multiple interlinked components.

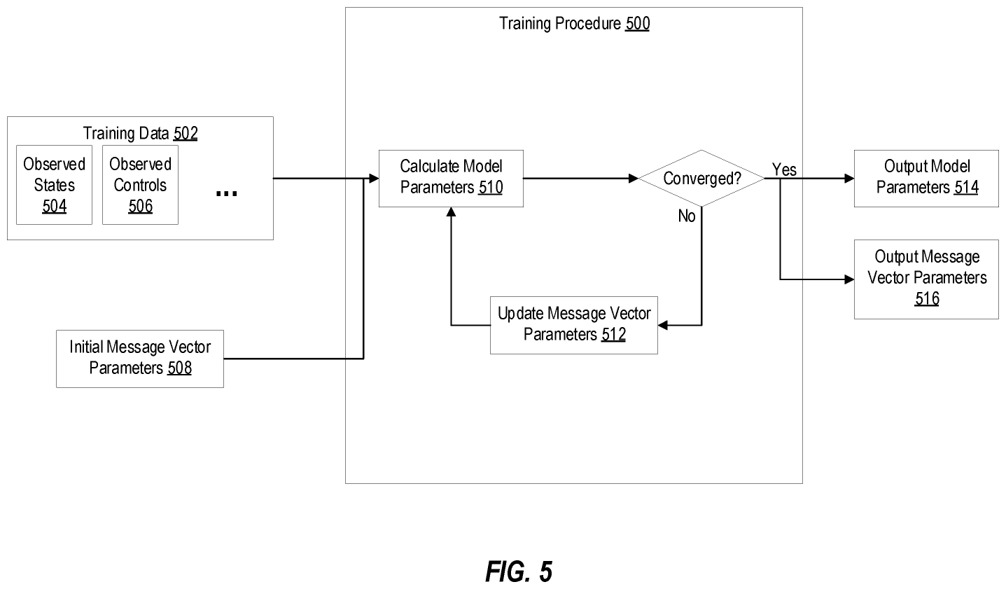

FIG. 5 illustrates an example conceptual representation of a training procedure 500 for training a deep simulation network. Such a training procedure 500 may be executed using processor(s) 102 of a system 100 to obtain parameters that configure simulation nodes of a deep simulation network (e.g., stored within storage 104) for simulating one or more physical processes or components.

FIG. 5 shows that a training procedure 500 may rely at least in part on training data 502, which may comprise one or more representations of observed states 504 of one or more physical processes and/or components, one or more representations of observed controls 506 associated with the observed states 504, and/or other data indicated by the ellipsis associated with the training data 502 (e.g., time duration data).

FIG. 5 also illustrates that a training procedure 500 may rely at least in part on initial message vector parameters 508. In some instances, the message vector parameters 508 are initialized to a predetermined value (e.g., zero) to enable message vector parameters to be iteratively updated throughout the training procedure 500. The message vector parameters may be associated with a set of message vectors (e.g., message vector inputs, message vector outputs) associated with various simulation nodes of a deep simulation network. The various simulation nodes may be associated with simulation frames corresponding to the observed states 504 and/or other components of the training data 502.

FIG. 5 illustrates that, in some implementations, the training procedure 500 may utilize the training data 502 and the initial message vector parameters 508 to train a deep simulation network (e.g., to output model parameters 514 and output message vector parameters 516). In some instances, this may involve taking a probabilistic perspective to learn the parameters, such as by maximizing a log-likelihood of the deep simulation network providing outputs corresponding to the training data 502. Such an approach may include treating message vector inputs and message vector outputs of the set of message vectors for the various simulation nodes of the deep simulation network as latent variables and marginalizing over the message vectors. For instance, maximizing the log-likelihood of the deep simulation network providing outputs corresponding to the training data 502 may include determining an approximation distribution over the set of message vectors that provides a tightest variational lower bound and determining model parameters that maximize the tightest variational lower bound. Based on such model parameters, the set of message vector parameters may then be updated to train the deep simulation network to implement message passing functionality to facilitate coordinated simulation of the evolution of one or more physical components or processes.

For example, under a probabilistic perspective of learning the parameters, given the full set of simulation nodes [symbol] of a deep simulation network with groups G∈ [symbol] connected via potential functions ψ_{G}, the following probability distribution over an observation sequence S (e.g., corresponding to training data 502) and the corresponding full set of messages M is provided:

$$p ( S , M \vert θ ) = \frac{1}{{Z}_{θ}} {ψ}_{G} {ϕ}_{g}$$

where Z_{θ} is the partition function (e.g., normalizing term) and if ϕ_{g} represents the individual potential associated with the deep simulation network for the particular simulation node g. Consequently, given the training data 502 that consists of several observation sequences [S₁]ᵢ₌₀^{N}, parameters θ that maximize the log likelihood of the deep simulation network providing output corresponding to the training data may be identified:

$$\begin{matrix}{θ}^{*} = arg {max}_{θ} log p ( {S}_{0} , … , {S}_{N} \vert θ ) \\ = arg {max}_{θ} {\sum }_{i = 0}^{N} log {\int }_{{M}_{i}} p ( {S}_{i} , {M}_{i} \vert θ ) .\end{matrix}$$

The second line of the above follows in view of the individual sequences being independent and of Mᵢ being latent random variables that need to be marginalized. As an alternative to utilizing the integral shown above, the variational lower bound may instead be taken as follows:

log ∫_{M}_{ᵢ}p(Sᵢ,Mᵢ|θ)≥Fᵢ(θ), where:

$${F}_{i} ( θ ) = {\int }_{{M}_{i}} q ( {M}_{i} ) log \frac{p ( {S}_{i} , {M}_{i} \vert θ )}{q ( {M}_{i} )}$$

where q(M₁) is an approximating distribution over the latent variable Mᵢ. Thus, calculating model parameters 510 according to the training procedure 500 may iterate between finding the best approximating distribution q(Mᵢ) that results in the tightest lower bound and then identifying the parameters θ that maximized that lower bound.

In some instances, the lower bound Fᵢ(θ) takes an appealing form when the approximating family is considered as a product of independent gaussian distributions with a spherical covariance. For instance, for q(Mᵢ)=Π_{f} [symbol] (mᵢⱼ;μᵢⱼ,cI), where the product iterates over all the individual messages pertinent to the entire sequence, the lower bound can be written as:

$${F}_{i} ( θ ) = {\int }_{{M}_{i G}} 𝒩 ( {M}_{i G} ; {μ}_{i G} , c I ) log {ψ}_{G} + {\int }_{{M}_{i g}} 𝒩 ( {M}_{i g} ; {μ}_{i g} ; c I ) log {ϕ}_{g} - log {Z}_{θ} + Constant .$$

Where M_{iG} and M_{ig} denote the collection of messages associated with the clique G and the simulation node g, respectively. In some instances, this form is especially useful if the potentials ψ and ϕ are either linear or quadratic in m_{iG} and m_{ig}, respectively. In such cases, each of the integral terms in the above equation reduces to the case where the potentials are evaluated with messages fixed to their respective means (i.e., Mᵢ=μᵢ). Thus, in some instances, the lower bound can simply be written as:

$${F}_{i} ( θ ) = log {ψ}_{G , {M}_{i} = {μ}_{i}} + log {ϕ}_{g , {M}_{i} = {μ}_{i}} - log {Z}_{θ} + Constant .$$

As noted above, the training procedure 500 iterates between finding the best lower bound and then optimizing the lower bound with respect to the parameters θ. Accordingly, the resulting training procedure 500 may follow a double loop algorithm that includes iterating between determining targets and then, given those targets, determining the parameters θ. Such a double loop procedure may be beneficial in view of the message vector inputs and message vector outputs being treated as latent. For instance, for every simulation node of a deep simulation network, inferring the incoming message as well as the output message may allow for refining the parameters of the deep simulation network.

FIG. 5 depicts various acts associated with the training procedure, including calculating model parameters 510. As noted above, calculating the model parameters 510 may include utilizing the training data 502 (e.g., Sᵢ) and initial message vector parameters 508 (e.g., μᵢ=0 for all i) to determine or update model parameters θ, which may be according to the following:

$$θ = arg {max}_{θ} {\sum }_{i = 0}^{N} log p ( {S}_{i} , {M}_{i} = {μ}_{i} \vert θ ) .$$

Based on the updated model parameters θ, the training procedure 500 may include determining if the updated model parameters θ cause the deep simulation network to converge to provide output corresponding to the training data 502. As shown in FIG. 5, while the model parameters θ fail to converge the deep simulation network, the training procedure 500 may include updating message vector parameters 512 based on the updated model parameters, which may be performed as follows for i=0 to N:

$${μ}_{i} = arg {max}_{{μ}_{i}} {F}_{i} ( θ ) .$$

Based on the updated message vector parameters μᵢ, the training procedure 500 may again calculate the model parameters 510 as noted above according to

$$θ = arg {max}_{θ} {\sum }_{i = 0}^{N} log p ( {S}_{i} , {M}_{i} = {μ}_{i} \vert θ ) .$$

The training procedure may iterate acts of calculating model parameters 510 and updating message vector parameters until convergence is reached, whereupon the training procedure 500 may output the model parameters 514 (θ) and, in some instances, output the message vector parameters 516 (μᵢ).

### Example Method(s) for Light Leak Correction

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

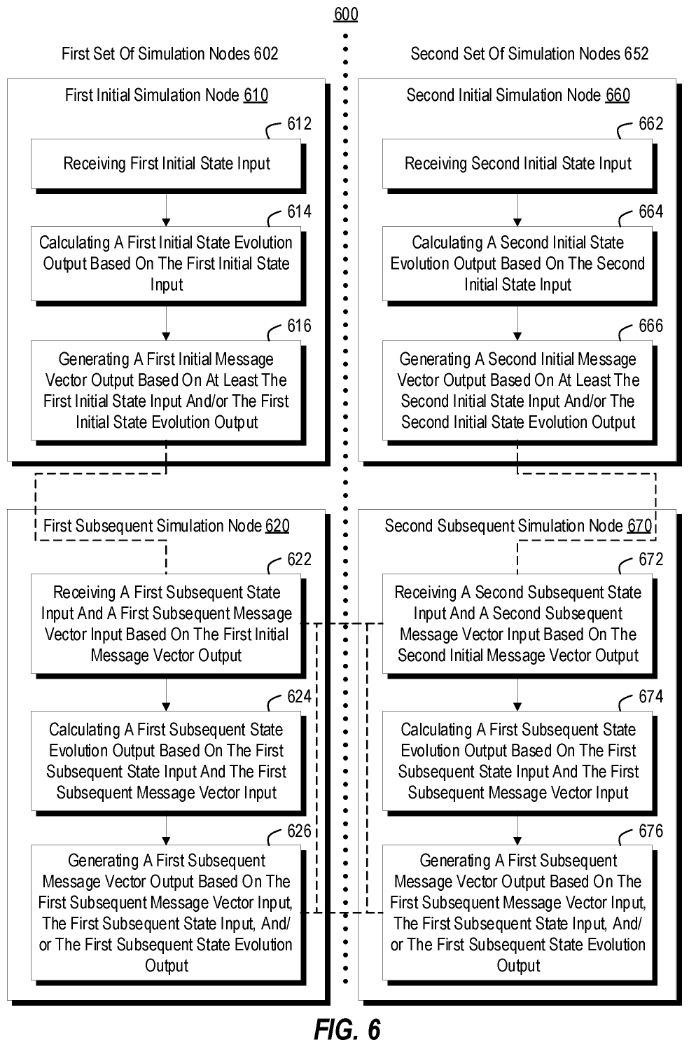

FIG. 6 illustrates an example flow diagram 600 that depicts acts associated with implementing deep simulation networks. The discussion of the various acts represented in flow diagram 600 include references to various hardware components described in more detail with reference to FIG. 1.

For example, flow diagram 600 illustrates act associated with a first set of simulation nodes 602 and a second set of simulation nodes 652. The first set of simulation nodes 602 and/or the second set of simulation nodes 652 may be stored in storage 104 of a system 100, and the sets of simulation nodes may be implemented by using processor(s) 102 to execute acts associated with the sets of simulation nodes as shown in FIG. 6.

The first set of simulation nodes 610 may be configured for simulating a first physical process or component, and the second set of simulation nodes 652 may be configured for simulating a second physical process or component that is interlinked with the first physical process or component. The first set of simulation nodes 602 may include a first initial simulation node 610 and a first subsequent simulation node 620, which may be associated with temporally consecutive simulation nodes. Similarly, the second set of simulation nodes 652 may include a second initial simulation node 660 and a second subsequent simulation node 670, which may also be associated with temporally consecutive simulation nodes.

At the first initial simulation node 610 of the first set of simulation nodes 602, act 612 of flow diagram 600 includes receiving first initial state input. Such initial state input may comprise any type of information describing a status or state associated with the first physical process or component.

Act 614 of flow diagram 600 at the first initial simulation node 610 includes calculating a first initial state evolution output based on the first initial state input. In some instances, wherein the first initial state evolution output corresponds to a time derivative of the first initial state input. In some instances, the first initial state evolution output is further based on first initial control input and/or first initial time duration input.

Act 616 of flow diagram 600 at the first initial simulation node includes generating a first initial message vector output based on at least the first initial state input and/or the first initial state evolution output. In some instances, the first initial message vector output is further based on first initial control input or first initial time duration input.

At the first subsequent simulation node 620 of the first set of simulation nodes 602, act 622 of flow diagram 600 includes receiving a first subsequent state input and a first subsequent message vector input based on the first initial message vector output. In some instances, the first subsequent state input is based on the first initial state input, the first initial state evolution output, and/or the first initial time duration input. In some implementations, receiving the first subsequent message vector input at the first subsequent simulation node facilitates coordination between the first initial and subsequent simulation nodes for calculating respective state evolution outputs for simulating the first physical process or component. For instance, operations at the first subsequent simulation node 620 may use incoming message vectors as a context for predictions.

Furthermore, in some implementations, coordination between the first initial simulation node and the first subsequent simulation node is defined by a potential function that comprises a first term that connects the first initial message vector output as the first subsequent message vector input at the first subsequent simulation node. The potential function may comprise a strictly positive and real function. In some instances, the potential function comprises a second term causing the first initial message vector output to approximate residual errors in a Taylor approximation. The second term may be based on the first initial state input, the first initial time duration input, the first initial state evolution output, and/or the first subsequent state input. The potential function may also comprise a hyperparameter that determines the relative strengths of the first term and the second term.

Act 624 of flow diagram 600 at the first subsequent simulation node 620 includes calculating a first subsequent state evolution output based on the first subsequent state input and the first subsequent message vector input. In some instances, first subsequent state evolution output corresponds to a time derivative of the first subsequent state input. Furthermore, in some instances, the first subsequent state evolution output is based on first subsequent control input and/or first subsequent time duration input.

Act 626 of flow diagram 600 at the first subsequent simulation node 620 includes generating a first subsequent message vector output based on the first subsequent message vector input, the first subsequent state input, and/or the first subsequent state evolution output. In some instances, the first subsequent message vector output is further based on first subsequent control input and/or first subsequent time duration input.

As noted above, flow diagram 600 depicts acts associated with the second initial simulation node 660 and the second subsequent simulation node 670 of the second set of simulation nodes 652. At least some of the acts associated with the second set of simulation nodes 652 are similar to those described hereinabove associated with the first set of simulation nodes 602. For example, at the second initial simulation node 660 of the second set of simulation nodes 652, act 662 of flow diagram 600 includes receiving second initial state input, while act 664 includes calculating a second initial state evolution output based on the second initial state input, and act 666 includes generating a second initial message vector output based at least on second initial state input and/or second initial state evolution output.

At the second subsequent simulation node 670 of the second set of simulation nodes 652, act 672 includes receiving a second subsequent message vector input and a second subsequent message vector input based on the second initial message vector output, act 674 includes calculating a first subsequent state evolution output based on the first subsequent state input and the first subsequent message vector input, and act 676 includes generating a second subsequent message vector output based at least on the second subsequent message vector input, second subsequent state input, and/or second subsequent state evolution output.

In some instances, a second potential function facilitates coordination between the first set of simulation nodes and the second set of simulation nodes to coordinate evolution of the first physical process or component with evolution of the second physical process or component. In some instances, the second potential function connects the first subsequent message vector input with the second subsequent message vector input or the second subsequent message vector output. Additionally, or alternatively, the second potential function connects the first subsequent message vector output with the second subsequent message vector input or the second subsequent message vector output. The connections among the message vector inputs and outputs of the various simulation nodes represented in flow diagram 600 are depicted with dashed lines in FIG. 6.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage hardware/media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g. as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A system configured for providing a neural network architecture that facilitates message passing among simulation nodes to allow coordination amongst simulation nodes to simulate one or more physical processes or components, the system comprising:
one or more hardware storage devices storing a first set of simulation nodes, the first set of simulation nodes including at least a first initial simulation node and at least a first subsequent simulation node, the first initial and subsequent simulation nodes being constructed according to a neural network computational fabric and being associated with temporally consecutive simulation frames for simulating a first physical process or component; and
one or more processors configured to implement the first set of simulation nodes by configuring the system to perform at least the following:
at the first initial simulation node:
receive first initial state input;
calculate a first initial state evolution output based on the first initial state input; and
generate a first initial message vector output based on at least the first initial state input and/or the first initial state evolution output; and
at the first subsequent simulation node:
receive a first subsequent state input and a first subsequent message vector input based on the first initial message vector output, wherein receiving the first subsequent message vector input at the first subsequent simulation node facilitates coordination between the first initial and subsequent simulation nodes for calculating respective state evolution outputs for simulating the first physical process or component;
calculate a first subsequent state evolution output based on the first subsequent state input and the first subsequent message vector input; and
generate a first subsequent message vector output based on the first subsequent message vector input, the first subsequent state input, and/or the first subsequent state evolution output.

2. The system of claim 1, wherein the first initial state evolution output corresponds to a time derivative of the first initial state input or the first subsequent state evolution output corresponds to a time derivative of the first subsequent state input.

3. The system of claim 1, wherein the first initial state evolution or the first initial message vector output are further based on first initial control input received at the first initial simulation node, or wherein the first subsequent state evolution or the first subsequent message vector output are further based on first subsequent control input received at the first subsequent simulation node.

4. The system of claim 1, wherein the first initial state evolution or the first initial message vector output are further based on first initial time duration input received at the first initial simulation node, or wherein the first subsequent state evolution or the first subsequent message vector output are further based on first subsequent time duration input received at the first subsequent simulation node.

5. The system of claim 4, wherein coordination between the first initial simulation node and the first subsequent simulation node is defined by a potential function that comprises a first term that connects the first initial message vector output as the first subsequent message vector input at the first subsequent simulation node.

6. The system of claim 5, wherein the potential function comprises a second term causing the first initial message vector output to approximate residual errors in a Taylor approximation, the second term being based on the first initial state input, the first initial time duration input, the first initial state evolution output, and/or the first subsequent state input.

7. The system of claim 6, wherein the potential function comprises a hyperparameter that determines relative strengths of the first term and the second term.

8. The system of claim 7, wherein the one or more hardware storage devices store a second set of simulation nodes comprising at least a second initial simulation node and at least a second subsequent simulation node, the second initial and subsequent simulation nodes being constructed according to a neural network computational fabric and being associated with temporally consecutive simulation frames for simulating a second physical process or component.

9. The system of claim 8, wherein the one or more processors are configured to implement the second set of simulation nodes by configuring the system to perform at least the following:
at the second initial simulation node:
generate a second initial message vector output based at least on second initial state input and/or second initial state evolution output; and
at the second subsequent simulation node:
receive a second subsequent message vector input based on the second initial message vector output; and
generate a second subsequent message vector output based at least on the second subsequent message vector input, second subsequent state input, and/or second subsequent state evolution output.

10. The system of claim 9, wherein a second potential function facilitates coordination between the first set of simulation nodes and the second set of simulation nodes to coordinate evolution of the first physical process or component with evolution of the second physical process or component.

11. The system of claim 10, wherein the second potential function connects the first subsequent message vector input with the second subsequent message vector input or the second subsequent message vector output.

12. The system of claim 10, wherein the second potential function connects the first subsequent message vector output with the second subsequent message vector input or the second subsequent message vector output.

13. A system configured for training a neural network architecture that facilitates message passing among simulation nodes to allow coordination amongst simulation nodes to simulate one or more physical processes or components, the system comprising:
one or more processors; and
one or more hardware storage devices storing:
a deep simulation network comprising a set of simulation nodes associated with temporally consecutive simulation frames for modeling a physical process or component, wherein the set of simulation nodes is configured with message passing functionality such that at least some of the set of simulation nodes are configured to generate message vector output and receive message vector input based on message vector output generated by other simulation nodes of the set of simulation nodes, wherein the message passing functionality facilitates coordination among the set of simulation nodes for simulating the physical process or component; and
instructions that are executable by the one or more processors to configure the system to train the deep simulation network by configuring the system perform at least the following:
obtain a set of observations that capture evolution of the physical process or component;
initialize a set of message vector parameters using a predetermined value, wherein the set of message vector parameters are associated with a set of message vectors corresponding to the set of observations, and wherein the set of message vectors comprises message vector inputs and message vector outputs associated with the set of simulation nodes;
determine model parameters for the deep simulation network by maximizing a log-likelihood of the deep simulation network providing outputs corresponding to the set of observations and by treating the message vector inputs and the message vector outputs of the set of message vectors as latent variables and marginalizing over the message vector inputs and the message vector outputs of the set of message vectors; and
update the set of message vector parameters based on the model parameters.

14. The system of claim 13, wherein maximizing the log-likelihood of the deep simulation network providing outputs corresponding to the set of observations comprises:
determining an approximation distribution over the set of message vectors that provides a tightest variational lower bound for maximizing the log-likelihood of the deep simulation network providing outputs corresponding to the set of observations; and
determining model parameters that maximize the tightest variational lower bound.

15. A method for providing a neural network architecture that facilitates message passing among simulation nodes to allow coordination amongst simulation nodes to simulate one or more physical processes or components, the method comprising:
accessing a first set of simulation nodes, the first set of simulation nodes including at least a first initial simulation node and at least a first subsequent simulation node, the first initial and subsequent simulation nodes being constructed according to a neural network computational fabric and being associated with temporally consecutive simulation frames for simulating a first physical process or component;
implementing the first set of simulation nodes by performing at least the following:
at the first initial simulation node:
receiving first initial state input;
calculating a first initial state evolution output based on the first initial state input; and
generating a first initial message vector output based on at least the first initial state input and/or the first initial state evolution output; and
at the first subsequent simulation node:
receiving a first subsequent state input and a first subsequent message vector input based on the first initial message vector output, wherein receiving the first subsequent message vector input at the first subsequent simulation node facilitates coordination between the first initial and subsequent simulation nodes for calculating respective state evolution outputs for simulating the first physical process or component;
calculating a first subsequent state evolution output based on the first subsequent state input and the first subsequent message vector input; and
generating a first subsequent message vector output based on the first subsequent message vector input, the first subsequent state input, and/or the first subsequent state evolution output.

16. The method of claim 15, wherein the first initial state evolution or the first initial message vector output are further based on first initial time duration input received at the first initial simulation node, or wherein the first subsequent state evolution or the first subsequent message vector output are further based on first subsequent time duration input received at the first subsequent simulation node.

17. The method of claim 16, wherein coordination between the first initial simulation node and the first subsequent simulation node is defined by a potential function that comprises:
a first term that connects the first initial message vector output as the first subsequent message vector input at the first subsequent simulation node; and
a second term that causes the first initial message vector output to approximate residual errors in a Taylor approximation, the second term being based on the first initial state input, the first initial time duration input, the first initial state evolution output, and/or the first subsequent state input.

18. The method of claim 17, further comprising:
accessing a second set of simulation nodes comprising at least a second initial simulation node and at least a second subsequent simulation node, the second initial and subsequent simulation nodes being constructed according to a neural network computational fabric and being associated with temporally consecutive simulation frames for simulating a second physical process or component.

19. The method of claim 18, further comprising:
at the second initial simulation node:
generating a second initial message vector output based at least on second initial state input and/or second initial state evolution output; and
at the second subsequent simulation node:
receiving a second subsequent message vector input based on the second initial message vector output; and
generating a second subsequent message vector output based at least on the second subsequent message vector input, second subsequent state input, and/or second subsequent state evolution output.

20. The method of claim 19, wherein a second potential function facilitates coordination between the first set of simulation nodes and the second set of simulation nodes to coordinate evolution of the first physical process or component with evolution of the second physical process or component.
